(19) United States
(12) Patent Application Publication
(10) Pub. No.: US 2018/0100511 A1
(43) Pub. Date: Apr. 12, 2018

(54) FAN MOTOR

(71) Applicant: NIDEC CORPORATION, Kyoto (JP)

(72) Inventor: Takehito Tamaoka, Kyoto (JP)

(73) Assignee: NIDEC CORPORATION, Kyoto (JP)

(21) Appl. No.: 15/725,648

(22) Filed: Oct. 5, 2017

(30) Foreign Application Priority Data
Oct. 7, 2016 (JP) 2016-199277

(51) Int. Cl. F04D 25/06; H02K 5/16; H02K 7/14; F04D 29/063; F04D 29/42; F04D 29/051

(52) U.S. Cl. CPC F04D 25/0606; H02K 5/16; H02K 7/14; F04D 29/281; F04D 29/4226; F04D 29/051; F04D 29/063

(57) ABSTRACT

This fan motor includes a motor and an impeller arranged to rotate together with a rotating portion of the motor. The motor includes a stationary portion including a stator, and the rotating portion, which includes a magnet arranged opposite to the stator and which is supported through a bearing portion to be rotatable about a central axis extending in a vertical direction with respect to the stationary portion. The stationary portion includes a shaft arranged to extend along the central axis, and an upper thrust portion arranged to extend radially outward from an upper portion of the shaft. The rotating portion includes a sleeve portion arranged radially opposite to the shaft and axially opposite to the upper thrust portion; and a rotor hub portion arranged to extend in an annular shape around the sleeve portion, and arranged to have the impeller fixed thereto. An upper end of the stationary portion is arranged at a level higher than that of an upper end of the rotating portion.

### BACKGROUND OF THE INVENTION

### 1. Field of the Invention

The present invention relates to a fan motor.

### 2. Description of the Related Art

High-performance electronic devices, such as, for example, notebook personal computers and tablet computers, typically have installed therein a fan motor to cool a CPU or the like in a casing thereof. Once the fan motor is driven, an air flow is generated in the casing. This leads to a reduction in accumulation of heat inside of the casing. The structure of a known fan motor is described in, for example, JP-A 2013-032769.

Due to recent reductions in thickness of notebook personal computers, tablet computers, and so on, the distance between an inner wall of a casing and a fan motor installed inside of the casing has become increasingly shorter. Accordingly, a fall of the casing or a pressing down of the casing may cause the inner wall of the casing to be brought into contact with the fan motor to cause an unusual sound or affect driving of the fan motor.

### SUMMARY OF THE INVENTION

The present invention has been conceived to provide a structure that does not allow a contact between an inner wall of a casing and a fan motor to affect driving of the fan motor.

A fan motor according to a preferred embodiment of the present invention includes a motor including a stationary portion including a stator, and a rotating portion supported through a bearing portion to be rotatable about a central axis extending in a vertical direction with respect to the stationary portion, the rotating portion including a magnet arranged opposite to the stator; and an impeller arranged to rotate together with the rotating portion of the motor. The stationary portion includes a shaft arranged to extend along the central axis, and an upper thrust portion arranged to extend radially outward from an upper portion of the shaft. The rotating portion includes a sleeve portion arranged radially opposite to the shaft and axially opposite to the upper thrust portion; and a rotor hub portion arranged to extend in an annular shape around the sleeve portion, and arranged to have the impeller fixed thereto. An upper end of the stationary portion is arranged at a level higher than that of an upper end of the rotating portion.

According to the above preferred embodiment of the present invention, the upper end of the stationary portion of the motor is arranged at a level higher than that of the upper end of the rotating portion of the motor. Accordingly, when an inner wall of a casing and the fan motor are brought into contact with each other, the inner wall of the casing will first be brought into contact with only the stationary portion of the motor. This contributes to preventing the contact between the inner wall of the casing and the fan motor from affecting driving of the fan motor.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a vertical sectional view of a fan motor according to a first preferred embodiment of the present invention.

FIG. 2 is a vertical sectional view of a fan motor according to a second preferred embodiment of the present invention.

FIG. 3 is a partial vertical sectional view of a motor according to the second preferred embodiment.

FIG. 4 is a partial vertical sectional view of the motor according to the second preferred embodiment.

FIG. 5 is a partial vertical sectional view of a sleeve portion according to the second preferred embodiment.

FIG. 6 is a bottom view of an upper thrust portion according to the second preferred embodiment.

FIG. 7 is a bottom view of the sleeve portion according to the second preferred embodiment.

FIG. 8 is a vertical sectional view of a motor according to a modification of the second preferred embodiment.

FIG. 9 is a partial vertical sectional view of a motor according to a modification of the second preferred embodiment.

### DETAILED DESCRIPTION OF THE PREFERRED EMBODIMENTS

Hereinafter, preferred embodiments of the present invention will be described with reference to the accompanying drawings. It is assumed herein that a direction along a central axis of a motor is referred to by the team “axial direction”, “axial”, or “axially”, that directions perpendicular to the central axis of the motor are each referred to by the term “radial direction”, “radial”, or “radially”, and that a direction along a circular arc centered on the central axis of the motor is referred to by the term “circumferential direction”, “circumferential”, or “circumferentially”. It is also assumed herein that an axial direction is a vertical direction, and that a side on which an upper thrust portion is arranged with respect to a sleeve portion is defined as an upper side. The shape of each member or portion and relative positions of different members or portions will be described based on the above assumptions. It should be noted, however, that the above definitions of the vertical direction and the upper and lower sides are made simply for the sake of convenience in description, and should not be construed to restrict in any way the orientation of a fan motor according to any preferred embodiment of the present invention when in use.

Also note that the team “parallel” as used herein includes both “parallel” and “substantially parallel”. Also note that the term “perpendicular” as used herein includes both “perpendicular” and “substantially perpendicular”.

### 1. First Preferred Embodiment

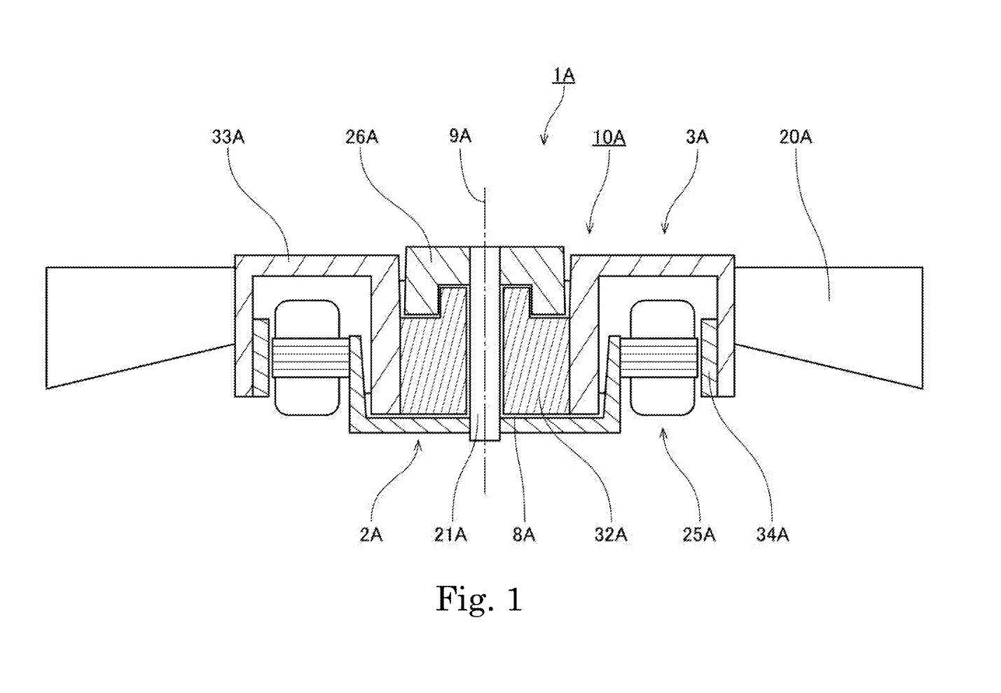

FIG. 1 is a vertical sectional view of a fan motor 1A according to a first preferred embodiment of the present invention. Referring to FIG. 1, the fan motor 1A includes a motor 10A and an impeller 20A. The motor 10A includes a rotating portion 3A and a stationary portion 2A including a stator 25A. The rotating portion 3A includes a magnet 34A arranged radially opposite to the stator 25A, and is supported through a bearing portion 8A to be rotatable about a central axis 9A, which extends in the vertical direction, with respect to the stationary portion 2A. The impeller 20A is arranged to rotate together with the rotating portion 3A of the motor 10A.

The stationary portion 2A includes a shaft 21A and an upper thrust portion 26A. The shaft 21A is a columnar member arranged to extend along the central axis 9A. The upper thrust portion 26A is arranged to extend radially outward from an upper portion of the shaft 21A.

The rotating portion 3A includes a sleeve portion 32A and a rotor hub portion 33A. An inner circumferential surface of the sleeve portion 32A is arranged radially opposite to an outer circumferential surface of the shaft 21A, and an upper surface of the sleeve portion 32A is arranged axially opposite to a lower surface of the upper thrust portion 26A. The rotor hub portion 33A is arranged to extend in an annular shape around the sleeve portion 32A. The impeller 20A is fixed to an outer circumferential surface of the rotor hub portion 33A.

Referring to FIG. 1, an upper end of the stationary portion 2A is arranged at a level higher than that of an upper end of the rotating portion 3A. Thus, if a downward force is applied from axially above to a casing in which the fan motor 1A is installed to cause an inner wall of the casing to approach the fan motor 1A, the inner wall of the casing will be brought into contact with the stationary portion 2A before touching the rotating portion 3A. This contributes to preventing rotation of the rotating portion 3A from being affected by the application of the downward force.

### 2. Second Preferred Embodiment

2-1. Structure of Fan Motor

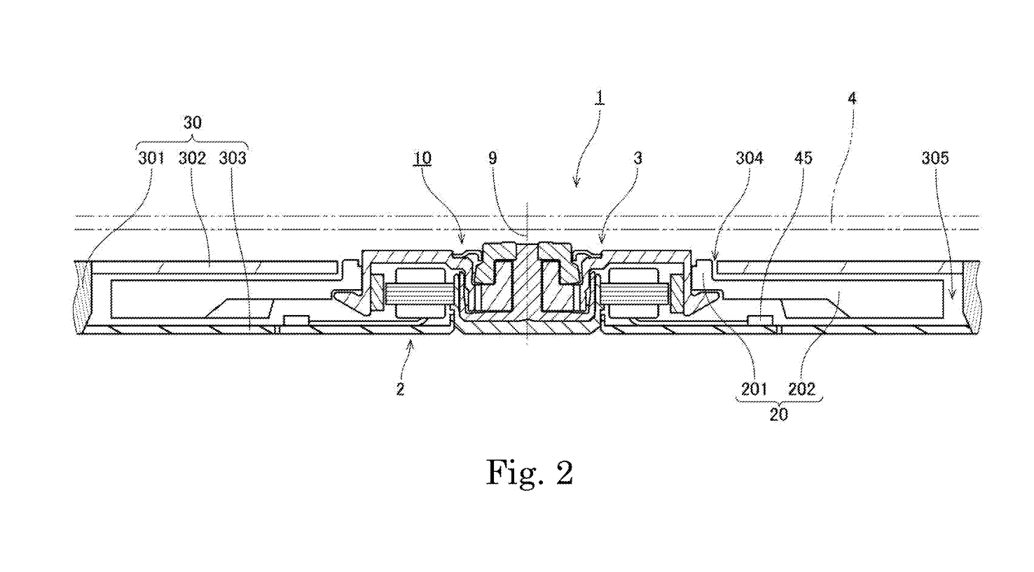

Next, a second preferred embodiment of the present invention will now be described below. FIG. 2 is a vertical sectional view of a fan motor 1 according to the second preferred embodiment.

The fan motor 1 is installed in a casing 4 of, for example, a notebook personal computer, and is used as an apparatus to supply a cooling air flow. Referring to FIG. 2, the fan motor 1 according to the present preferred embodiment includes a motor 10, an impeller 20, and a housing 30.

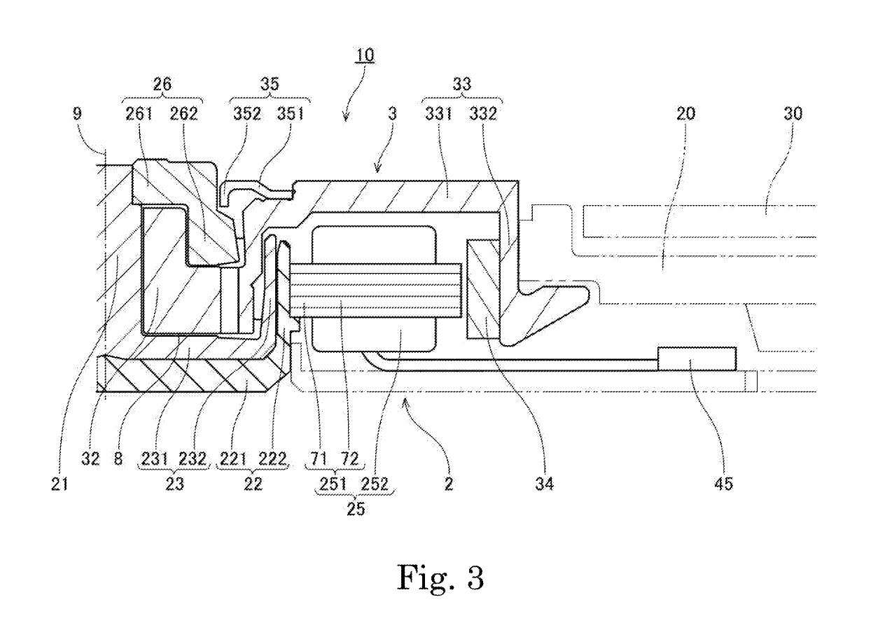

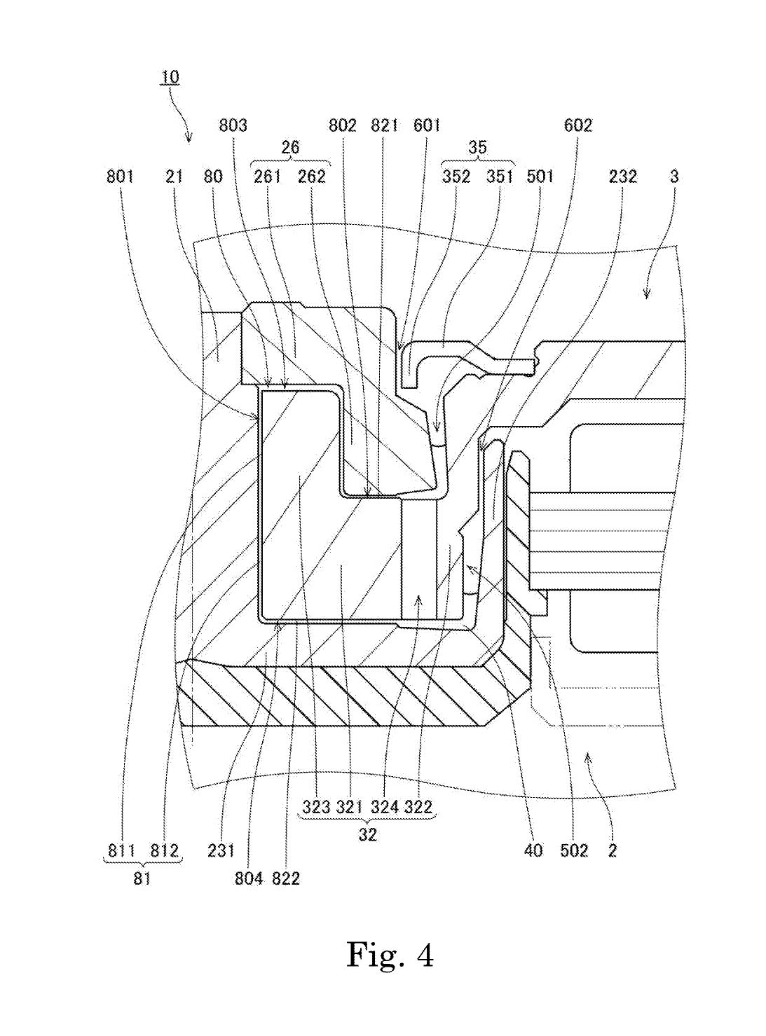

The motor 10 is a device to cause the impeller 20, which will be described below, to rotate in accordance with electric drive currents. First, the structure of the motor 10 will now be described below. Each of FIGS. 3 and 4 is a partial vertical sectional view of the motor 10. Referring to FIG. 3, the motor 10 includes a stationary portion 2, which is arranged to be stationary relative to the housing 30, which will be described below, and a rotating portion 3, which is supported to be rotatable with respect to the stationary portion 2 and which is arranged to rotate about a central axis 9 extending in the vertical direction.

The stationary portion 2 includes a shaft 21, a base portion 22, a cup portion 23, a stator 25, and an upper thrust portion 26.

The shaft 21 is a columnar member arranged to extend in the axial direction along the central axis 9 extending in the vertical direction. The shaft 21 is made, for example, of a metal, such as stainless steel or the like. The upper thrust portion 26 is fixed to an upper end portion of the shaft 21. In addition, the cup portion 23 is arranged on a lower end portion of the shaft 21. Further, the lower end portion of the shaft 21 is fixed to the base portion 22 through the cup portion 23.

The base portion 22 is made, for example, of a metal, such as an aluminum alloy or the like. The base portion 22 includes a bottom plate portion 221 arranged to extend radially, and a substantially cylindrical holder portion 222 arranged to project upward from an outer edge of the bottom plate portion 221. An inner edge portion of a lower plate 303 of the housing 30, which will be described below, is fixed to an outer circumferential surface of a lower portion of the base portion 22 through, for example, an adhesive. In addition, an inner circumferential surface of the stator 25, which will be described below, is fixed to an outer circumferential surface of the holder portion 222. Further, the cup portion 23, which will be described below, is inserted radially inside of the holder portion 222.

The cup portion 23 is a portion in the shape of a circular ring and arranged on the lower end portion of the shaft 21. In the present preferred embodiment, the shaft 21 and the cup portion 23 are defined by a single continuous monolithic member. Note that the shaft 21 and the cup portion 23 may alternatively be defined by separate members. The cup portion 23 includes a circular plate portion 231 arranged to extend radially outward from the shaft 21, and a substantially cylindrical wall portion 232 arranged to extend upward from an outer edge of the circular plate portion 231. A lower surface of the circular plate portion 231 and an outer circumferential surface of the wall portion 232 are fixed to an upper surface of the bottom plate portion 221 of the base portion 22 and an inner circumferential surface of the holder portion 222 of the base portion 22, respectively. The cup portion 23 is arranged to substantially assume the shape of the letter “L” in a vertical section with the circular plate portion 231 and the wall portion 232.

The stator 25 is an armature including a stator core 251 and a plurality of coils 252. The stator 25 is arranged at a level higher than that of the bottom plate portion 221 of the base portion 22. The stator core 251 is defined by laminated steel sheets, that is, electromagnetic steel sheets placed one upon another in the axial direction, for example. The stator core 251 includes a core back 71 in the shape of a circular ring, and a plurality of teeth 72. The core back 71 is fixed to the outer circumferential surface of the holder portion 222 of the base portion 22 through, for example, an adhesive. The teeth 72 are arranged to project radially outward from the core back 71. Each coil 252 is defined by a conducting wire wound around a separate one of the teeth 72. The teeth 72 and the coils 252 are preferably arranged in the shape of a circular ring and at substantially regular intervals in a circumferential direction about the central axis 9.

The upper thrust portion 26 is a member substantially in the shape of a circular ring, and fixed to an outer circumferential surface of the shaft 21. The upper thrust portion 26 is arranged to surround the shaft 21 at a level higher than that of the circular plate portion 231 of the cup portion 23. The upper thrust portion 26 is press fitted to the upper end portion of the shaft 21, and is fixed to the shaft 21 through an adhesive. Note that the shaft 21 and the upper thrust portion 26 may alternatively be defined by a single continuous monolithic member. The upper thrust portion 26 according to the present preferred embodiment includes a plate portion 261 and a hanging portion 262. The plate portion 261 is fixed to an outer circumferential surface of the upper end portion of the shaft 21, and is arranged to extend radially outward from the shaft 21. The hanging portion 262 is arranged to extend downward from an outer edge portion of the plate portion 261 to assume a substantially cylindrical shape. More specifically, the hanging portion 262 is arranged to extend downward from a lower surface of the outer edge portion of the plate portion 261. In the present preferred embodiment, the hanging portion 262 refers to a portion of the upper thrust portion 26 which is on a lower side of an imaginary plane which includes a lower surface of the plate portion 261 and a radially outward extension of the lower surface of the plate portion 261.

The rotating portion 3 includes a sleeve portion 32, a rotor hub portion 33, a magnet 34, and a cap 35.

The sleeve portion 32 is arranged to rotate about the central axis 9 around the shaft 21. Referring to FIG. 4, the sleeve portion 32 includes an annular portion 321, an outer cylindrical portion 322, an inner cylindrical portion 323, and a communicating hole 324. The annular portion 321 is substantially in the shape of a circular ring. The annular portion 321 includes the communicating hole 324, which is arranged to extend in the axial direction from an upper surface to a lower surface thereof at one circumferential position. The outer cylindrical portion 322 is a substantially cylindrical portion arranged to extend upward from an outer edge of the annular portion 321. The inner cylindrical portion 323 is a substantially cylindrical portion arranged to extend upward from an inner edge of the annular portion 321. An inner circumferential surface of the annular portion 321 and an inner circumferential surface of the inner cylindrical portion 323 together define a single continuous surface as an inner circumferential surface of the sleeve portion 32. The inner circumferential surface of the sleeve portion 32 and the outer circumferential surface of the shaft 21 are arranged radially opposite to each other with a slight gap therebetween. The annular portion 321 and the inner cylindrical portion 323 of the sleeve portion 32 are arranged axially between the plate portion 261 of the upper thrust portion 26 and the circular plate portion 231 of the cup portion 23.

In addition, an outer circumferential surface of the inner cylindrical portion 323 of the sleeve portion 32 and an inner circumferential surface of the hanging portion 262 of the upper thrust portion 26 are arranged radially opposite to each other. This contributes to maintaining radial rigidity, and leads to stable rotation of the motor 10. In addition, an axially extending gap between the outer circumferential surface of the inner cylindrical portion 323 and the inner circumferential surface of the hanging portion 262 can be used as an oil buffer to store a lubricating oil 40, which will be described below. This contributes to, for example, reducing the radial dimension of a radially extending gap between an upper surface of the inner cylindrical portion 323 and the plate portion 261 of the upper thrust portion 26, in which the lubricating oil 40 is arranged as well. This in turn contributes to reducing the radial dimension of the motor 10. Further, an increase in the amount of the lubricating oil 40 that can be injected into a whole gap between the stationary and rotating portions 2 and 3 can be achieved.

The rotor hub portion 33 is arranged to extend in an annular shape around the sleeve portion 32. The rotor hub portion 33 includes a top plate portion 331 and a tubular portion 332. The top plate portion 331 is a substantially disk-shaped portion arranged to extend radially outward from an upper end of the outer cylindrical portion 322 of the sleeve portion 32. The tubular portion 332 is a substantially cylindrical portion arranged to extend downward from an outer edge of the top plate portion 331. An inner circumferential surface of a blade support portion 201 of the impeller 20, which will be described below, is fixed to an outer circumferential surface of the tubular portion 332.

In the present preferred embodiment, the sleeve portion 32 and the rotor hub portion 33 are defined by a single continuous monolithic member. The sleeve portion 32 and the rotor hub portion 33 are made, for example, of a metal, such as ferromagnetic stainless steel or the like. Note that the sleeve portion 32 and the rotor hub portion 33 may alternatively be defined by separate members.

The magnet 34 is fixed to an inner circumferential surface of the tubular portion 332 of the rotor hub portion 33 through, for example, an adhesive. In the motor 10 according to the present preferred embodiment, a permanent magnet is used as the magnet 34. The magnet 34 is cylindrical or substantially cylindrical in shape, and is arranged radially outside of the stator 25. An inner circumferential surface of the magnet 34 is a pole surface in which north and south poles alternate with each other in the circumferential direction. In addition, the inner circumferential surface of the magnet 34 is arranged radially opposite to a radially outer end surface of each of the teeth 72 of the stator 25 with a slight gap therebetween. Note that a plurality of magnets may be used in place of the cylindrical or substantially cylindrical magnet 34. In the case where the plurality of magnets are used, the plurality of magnets are arranged on the inner circumferential surface of the tubular portion 332 of the rotor hub portion 33 such that north and south poles alternate with each other in the circumferential direction. Note that the magnet 34 may be directly fixed to the rotor hub portion 33, or be indirectly fixed thereto with another member therebetween.

The cap 35 is an annular member fixed to an upper surface of the top plate portion 331 of the rotor hub portion 33. The cap 35 is arranged above an upper capillary seal portion 501, which will be described below. The cap 35 is obtained, for example, by subjecting a metal to press working. Note that the cap 35 may alternatively be obtained by another method, and may alternatively be a resin-molded article. The cap 35 according to the present preferred embodiment includes a plate-shaped portion 351 and a projecting portion 352. The plate-shaped portion 351 is arranged to extend radially to substantially assume the shape of a disk. An outer end portion of the plate-shaped portion 351 is fixed to the top plate portion 331 of the rotor hub portion 33. The projecting portion 352 is arranged to project downward from an inner edge of the plate-shaped portion 351. An inner circumferential surface of the projecting portion 352 is arranged radially opposite to an outer circumferential surface of the upper thrust portion 26 with a slight gap 601 therebetween.

Referring to FIGS. 3 and 4, the lubricating oil 40 is arranged in a minute gap 80 between the sleeve portion 32 and a combination of the shaft 21, the cup portion 23, and the upper thrust portion 26. An oil including an ester as a main component, such as a polyolester oil or a diester oil, is used as the lubricating oil 40, for example. In addition, the rotating portion 3 is supported to be rotatable with respect to the stationary portion 2 through the lubricating oil 40. That is, in the present preferred embodiment, the shaft 21, the cup portion 23, the upper thrust portion 26, the sleeve portion 32, and the lubricating oil 40 are arranged to together define a bearing portion 8 arranged to connect the stationary and rotating portions 2 and 3 to each other such that the rotating portion 3 is rotatable relative to the stationary portion 2. The structure of the bearing portion 8 will be described in detail below. Since the stationary and rotating portions 2 and 3 are arranged opposite to each other with the gap 80, which has the lubricating oil 40 arranged therein, therebetween, the likelihood that a downward force applied to the fan motor 1 from axially above will bring the stationary and rotating portions 2 and 3 into contact with each other is reduced.

Reference is made again to FIG. 2. The impeller 20 includes the blade support portion 201 and a plurality of blade portions 202. The inner circumferential surface of the blade support portion 201 is fixed to an outer circumferential surface of the rotor hub portion 33 of the motor 10. Each blade portion 202 is arranged to extend radially outward from the blade support portion 201. The blade portions 202 are arranged at regular intervals in the circumferential direction. The blade support portion 201 and the blade portions 202 are defined as a single continuous monolithic member by a resin injection molding process, for example. Note that the blade support portion 201 and the blade portions 202 may alternatively be defined by separate members. As described below, the blade support portion 201 and the blade portions 202 are arranged to rotate about the central axis 9 together with the rotating portion 3 of the motor 10.

The housing 30 includes a side wall portion 301, an upper plate 302, and the lower plate 303. The side wall portion 301 is arranged to partially join an outer edge portion of the upper plate 302 and an outer edge portion of the lower plate 303 to each other radially outside of the impeller 20, and is arranged to house at least a portion of the motor 10 and at least a portion of the impeller 20 radially inside thereof. The upper plate 302 is arranged to extend radially inward from an upper end of the side wall portion 301 to cover at least a portion of an upper surface of the impeller 20. The lower plate 303 is arranged to extend radially inward from a lower end of the side wall portion 301 to cover at least a portion of a lower surface of the impeller 20. The outer circumferential surface of the lower portion of the base portion 22 is fixed to the inner edge portion of the lower plate 303 through, for example, the adhesive. Note that the lower plate 303 and the base portion 22 may alternatively be defined by a single continuous monolithic member. As described above, at least a portion of the motor 10 and at least a portion of the impeller 20 are housed in a casing of the fan motor 1, the casing being defined by the housing 30 and the base portion 22. A circuit board 45, which is arranged to supply electric drive currents to the coils 252 of the stator 25, is arranged on an upper surface of the lower plate 303.

In the fan motor 1 as described above, once the electric drive currents are supplied to the coils 252 of the stator 25 through the circuit board 45, radial magnetic flux is generated around each of the teeth 72 of the stator core 251. Then, interaction between the magnetic flux of the teeth 72 and magnetic flux of the magnet 34 produces a circumferential torque, so that the rotating portion 3 is caused to rotate about the central axis 9 with respect to the stationary portion 2. The impeller 20, which is supported by the rotor hub portion 33, is caused to rotate about the central axis 9 together with the rotating portion 3.

Here, referring to FIGS. 2 to 4, in the motor 10 according to the present preferred embodiment, at least a portion of at least one of the shaft 21 and the upper thrust portion 26 is arranged at a level higher than that of an upper end of the impeller 20. That is, with the shaft 21 of the motor 10 being fixed, an upper end of the stationary portion 2, which includes the shaft 21 and the upper thrust portion 26, is arranged at a level higher than that of the upper end of the impeller 20 and that of an upper end of the rotating portion 3, which includes the rotor hub portion 33. Thus, if the casing 4 of, for example, the notebook personal computer, in which the fan motor 1 is installed, falls, for example, to cause an inner wall of the casing 4 to approach the fan motor 1, the inner wall will be brought into contact with the shaft 21 or the upper thrust portion 26 of the stationary portion 2, which has a high rigidity, before touching the impeller 20 or the rotor hub portion 33 of the rotating portion 3. This contributes to preventing rotation of the impeller 20 and the rotating portion 3 from being affected by, for example, the fall of the casing 4. Further, at least a portion of the upper thrust portion 26 is arranged at a level higher than that of an upper end of the shaft 21 and that of an upper end of the rotor hub portion 33. This allows a force from the inner wall of the casing 4 to be received by an upper surface of the upper thrust portion 26, which extends radially, and to be thus distributed over a relatively wide area, so that an effect of the contact can be further reduced.

In addition, referring to FIG. 2, at least a portion of at least one of the shaft 21 and the upper thrust portion 26 is arranged at a level higher than that of an upper end of the upper plate 302 of the housing 30. Thus, if the inner wall of the casing 4 of, for example, the notebook personal computer, in which the fan motor 1 is installed, is caused to approach the fan motor 1, the inner wall will be brought into contact with the shaft 21 or the upper thrust portion 26 before touching the upper plate 302 of the housing 30. This reduces the likelihood that the inner wall will be brought into contact with the upper plate 302 of the housing 30 to cause the upper plate 302 to be defamed downwardly and be brought into contact with the impeller 20 to affect the rotation of the rotating portion 3.

Next, flows of air in the housing 30 will now be described below. Referring to FIG. 2, a gap between the impeller 20 and an inner edge portion of the upper plate 302 of the housing 30 defines an air inlet 304 on the upper side. In a plan view, the air inlet 304 on the upper side is circular and is centered on the central axis 9. In addition, the side wall portion 301 of the housing 30 includes an air outlet (not shown) at one circumferential position. Note that each of the air inlet 304 and the air outlet may alternatively be defined at any other desirable position. For example, in place of or in addition to the air inlet 304 defined at the gap between the impeller 20 and the inner edge portion of the upper plate 302 of the housing 30, an air inlet 304 may be arranged to pass through the lower plate 303 of the housing 30 in the axial direction. Defining the air inlet 304 and the air outlet in the housing 30 in the above-described manner allows the fan motor 1 to function as a centrifugal fan.

The rotation of the impeller 20 causes gas to be sucked into the housing 30 in the axial direction through the air inlet 304 on the upper side. The gas sucked into the housing 30 travels radially outward, receives a centrifugal force caused by the impeller 20, and flows in the circumferential direction in a wind channel 305 between the impeller 20 and the side wall portion 301. The gas is then caused to travel from the wind channel 305 to the air outlet, and be discharged out of the housing 30 through the air outlet.

2-2. Structure of Fluid Dynamic Pressure Bearing Portion

Next, the structure of the bearing portion 8 will now be described in detail below. Hereinafter, reference will be made to FIGS. 2 and 3 appropriately as well as FIGS. 4, 5, 6, and 7. As described above, the lubricating oil 40 is arranged in the minute gap 80 between the sleeve portion 32 and the combination of the shaft 21, the cup portion 23, and the upper thrust portion 26. As described below, the gap 80 includes a radial gap 801, a first thrust gap 802, a gap 803, a second thrust gap 804, the upper capillary seal portion 501, and a lower capillary seal portion 502.

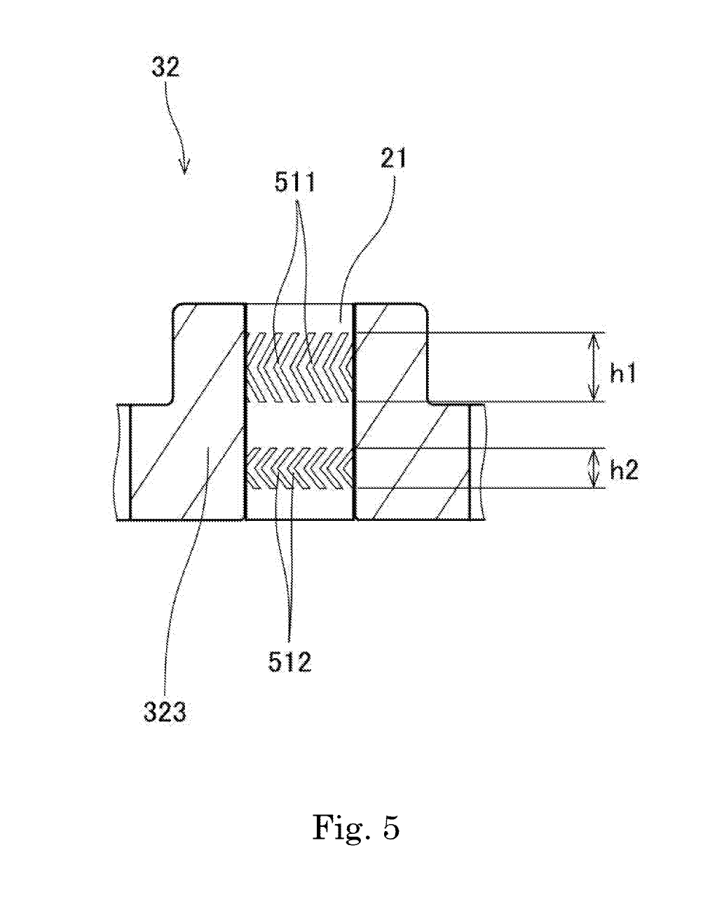

FIG. 5 is a partial vertical sectional view of the sleeve portion 32. Referring to FIG. 5, the inner cylindrical portion 323 of the sleeve portion 32 includes an upper radial groove array 511 and a lower radial groove array 512 in the inner circumferential surface thereof. The lower radial groove array 512 is arranged axially below the upper radial groove array 511. Each of the upper and lower radial groove arrays 511 and 512 is a groove array arranged in a so-called herringbone pattern. While the motor 10 is running, the upper and lower radial groove arrays 511 and 512 induce a dynamic pressure in a portion of the lubricating oil 40 which is present in the radial gap 801 between the inner circumferential surface of the sleeve portion 32 and the outer circumferential surface of the shaft 21. This produces a radial supporting force by the sleeve portion 32 for the shaft 21.

That is, in this motor 10, the inner circumferential surface of the sleeve portion 32 and the outer circumferential surface of the shaft 21 are arranged radially opposite to each other with the lubricating oil 40 therebetween to define a radial bearing portion 81. In addition, the radial bearing portion 81 includes an upper radial bearing portion 811 arranged to generate a dynamic pressure through the upper radial groove array 511, and a lower radial bearing portion 812 arranged to generate a dynamic pressure through the lower radial groove array 512. The lower radial bearing portion 812 is arranged axially below the upper radial bearing portion 811. Note that it may be sufficient if each of the upper and lower radial groove arrays 511 and 512 is defined in at least one of the inner circumferential surface of the sleeve portion 32 and the outer circumferential surface of the shaft 21. Also note that the number of radial groove arrays may alternatively be one or more than two.

In addition, referring to FIG. 5, in this motor 10, an axial dimension h1 of the upper radial groove array 511 is arranged to be greater than an axial dimension h2 of the lower radial groove array 512. Therefore, an axial dimension of the upper radial bearing portion 811 is greater than an axial dimension of the lower radial bearing portion 812. This causes the lubricating oil 40 to generate a stronger dynamic pressure at a position closer to a center of gravity of the rotating portion 3. This leads to a more stable posture of the rotating portion 3 during the rotation thereof.

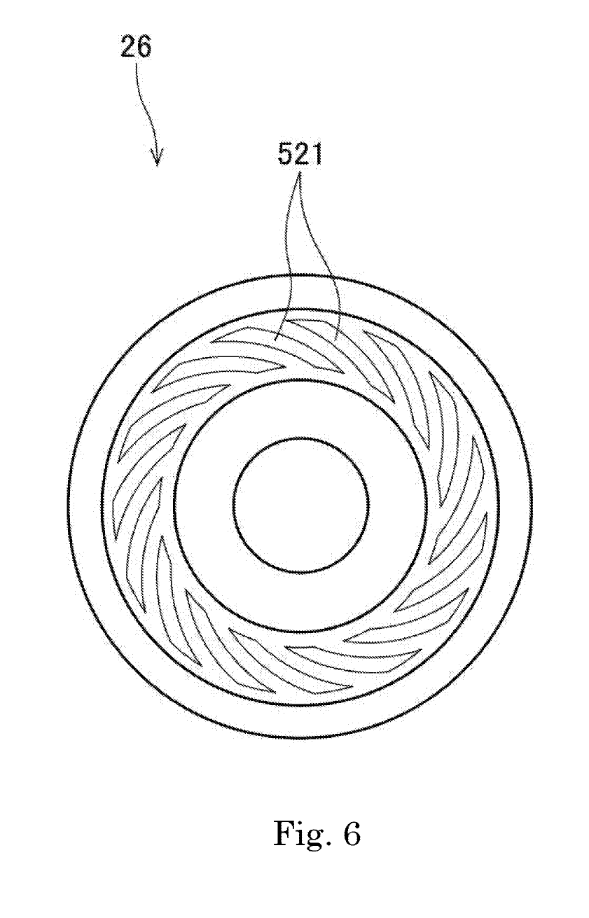

FIG. 6 is a bottom view of the upper thrust portion 26. Referring to FIG. 6, the hanging portion 262 of the upper thrust portion 26 includes a first thrust groove array 521 in a lower surface thereof. The first thrust groove array 521 includes a plurality of thrust grooves arranged in the circumferential direction. The thrust grooves are arranged to extend radially in a spiral shape. Note that the first thrust groove array 521 may alternatively be arranged in a herringbone pattern. While the motor 10 is running, the first thrust groove array 521 induces a fluid dynamic pressure in a portion of the lubricating oil 40 which is present in the first thrust gap 802 between the lower surface of the hanging portion 262 of the upper thrust portion 26 and the upper surface of the annular portion 321 of the sleeve portion 32. This produces an axial supporting force by the annular portion 321 of the sleeve portion 32 for the hanging portion 262 of the upper thrust portion 26, stabilizing the rotation of the rotating portion 3.

That is, in this motor 10, the lower surface of the hanging portion 262 of the upper thrust portion 26 of the stationary portion 2 and the upper surface of the annular portion 321 of the sleeve portion 32 of the rotating portion 3 are arranged axially opposite to each other with the first thrust gap 802, which has the lubricating oil 40 arranged therein, therebetween to define a first thrust bearing portion 821. Note that it may be sufficient if the first thrust groove array 521 is defined in at least one of the lower surface of the hanging portion 262 of the upper thrust portion 26 and the upper surface of the annular portion 321 of the sleeve portion 32. Note that the first thrust bearing portion 821 is preferably arranged at a level lower than that of an upper end of each blade portion 202 of the impeller 20. This leads to a reduction in the axial dimension of the fan motor 1.

Note that the first thrust bearing portion 821 may alternatively be defined at a position at which the lower surface of the plate portion 261 of the upper thrust portion 26 of the stationary portion 2 and the upper surface of the inner cylindrical portion 323 of the sleeve portion 32 of the rotating portion 3 are arranged axially opposite to each other with the gap 803, which has the lubricating oil 40 arranged therein, therebetween.

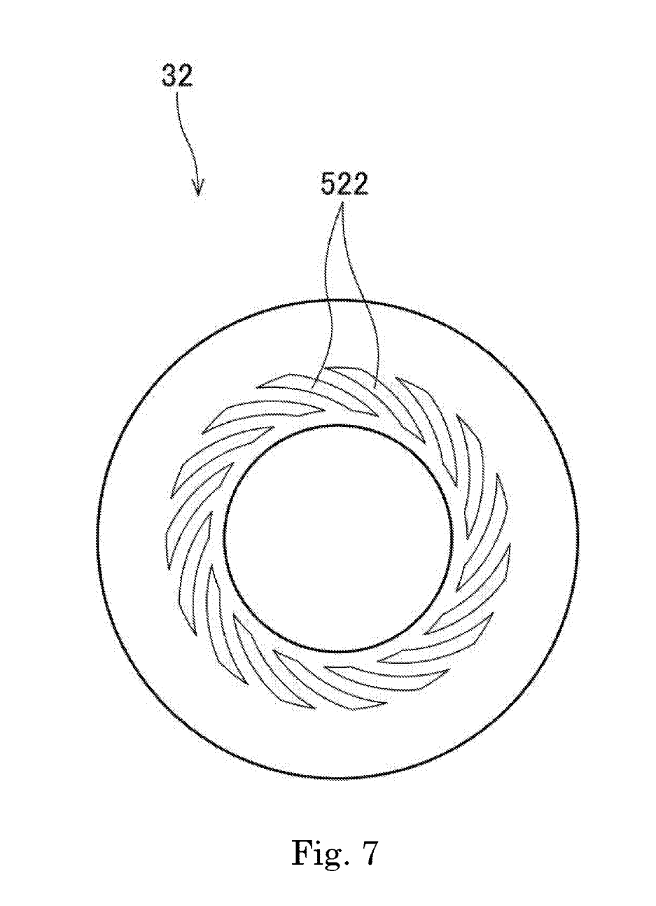

FIG. 7 is a bottom view of the sleeve portion 32. Referring to FIG. 7, the sleeve portion 32 includes a second thrust groove array 522 in a lower surface thereof. The second thrust groove array 522 includes a plurality of thrust grooves arranged in the circumferential direction. The thrust grooves are arranged to extend radially in a spiral shape. Note that the second thrust groove array 522 may alternatively be arranged in a herringbone pattern. While the motor 10 is running, the second thrust groove array 522 induces a fluid dynamic pressure in a portion of the lubricating oil 40 which is present in the second thrust gap 804 between the lower surface of the sleeve portion 32 and an upper surface of the circular plate portion 231 of the cup portion 23. This produces an axial supporting force by the sleeve portion 32 for the circular plate portion 231 of the cup portion 23, stabilizing the rotation of the rotating portion 3.

That is, in this motor 10, the lower surface of the sleeve portion 32 of the rotating portion 3 and the upper surface of the circular plate portion 231 of the cup portion 23 of the stationary portion 2 are arranged axially opposite to each other with the second thrust gap 804, which has the lubricating oil 40 arranged therein, therebetween at a level lower than that of the above-described first thrust gap 802 to define a second thrust bearing portion 822. Note that it may be sufficient if the second thrust groove array 522 is defined in at least one of the lower surface of the sleeve portion 32 and the upper surface of the circular plate portion 231 of the cup portion 23.

As described above, the thrust bearing portion is defined at each of the first and second thrust gaps 802 and 804, which are arranged at mutually different levels, and this leads to more stable rotation of the motor 10. In addition, a reduction in the likelihood that the stationary and rotating portions 2 and 3 will be brought into contact with each other when an upward or downward shock is applied to the motor 10 is achieved. Note that the motor 10 may alternatively include three or more thrust bearing portions, and that the thrust bearing portion may alternatively be defined at only one of the first and second thrust gaps 802 and 804.

The lubricating oil 40 is continuously arranged in the gap 80, which includes the radial gap 801, the first thrust gap 802, the gap 803, the second thrust gap 804, the upper capillary seal portion 501, which will be described below, and the lower capillary seal portion 502, which will be described below, between the stationary and rotating portions 2 and 3 and the communicating hole 324, which is arranged to pass through the sleeve portion 32 in the axial direction. This can be called a full-fill structure, and the adoption of the full-fill structure contributes to reducing swinging of the rotating portion 3 due to the orientation of the motor 10 installed, a vibration, and/or the like. In addition, a contact between the stationary and rotating portions 2 and 3 can be prevented when a shock is applied to the motor 10 during the rotation of the motor 10. The rotating portion 3 is arranged to rotate while being radially supported by the radial bearing portion 81. The rotating portion 3 is arranged to rotate while being axially supported by the first and second thrust bearing portions 821 and 822.

Referring to FIG. 4, when the motor 10 is stationary, an upper liquid surface of the lubricating oil 40 is positioned in the upper capillary seal portion 501, which is defined by an outer circumferential surface of the hanging portion 262 of the upper thrust portion 26 and an inner circumferential surface of the outer cylindrical portion 322 of the sleeve portion 32. In addition, when the motor 10 is stationary, a lower liquid surface of the lubricating oil 40 is positioned in the lower capillary seal portion 502, which is defined by an outer circumferential surface of the outer cylindrical portion 322 and an inner circumferential surface of the wall portion 232 of the cup portion 23. Each of the upper and lower liquid surfaces of the lubricating oil 40 thus defines a meniscus by surface tension. This contributes to preventing the lubricating oil 40 from leaking through the upper liquid surface or the lower liquid surface.

In addition, an outer circumferential portion of a gap at which the lower surface of the hanging portion 262 of the upper thrust portion 26 and a portion of an upper surface of the sleeve portion 32 in the vicinity of the communicating hole 324 are axially opposite to each other is arranged to increase in axial dimension in a radially outward direction. This enables any air bubble generated in the lubricating oil 40 in this gap to be carried toward the upper capillary seal portion 501. That is, the likelihood that any air bubble will stay in the gap is reduced, and an improvement in efficiency in discharge of air bubbles is achieved. Similarly, an outer circumferential portion of a gap at which the upper surface of the circular plate portion 231 of the cup portion 23 and a portion of the lower surface of the sleeve portion 32 in the vicinity of the outer cylindrical portion 322 are axially opposite to each other is arranged to increase in axial dimension in the radially outward direction. This enables any air bubble generated in the lubricating oil 40 in this gap to be carried toward the lower capillary seal portion 502, and similarly, the likelihood that any air bubble will stay in the gap is reduced, and an improvement in efficiency in discharge of air bubbles is achieved.

Further, the outer circumferential surface of the upper thrust portion 26 and the inner circumferential surface of the projecting portion 352 of the cap 35 are arranged radially opposite to each other with the slight gap 601 therebetween. Thus, entrance and exit of gas through the gap 601 are limited. This contributes to reducing evaporation of the lubricating oil 40 through the upper liquid surface of the lubricating oil 40. Similarly, the outer circumferential surface of the outer cylindrical portion 322 of the sleeve portion 32 and an inner circumferential surface of an upper portion of the wall portion 232 of the cup portion 23 are arranged radially opposite to each other with a slight gap 602 therebetween. Thus, entrance and exit of gas through the gap 602 are limited. This contributes to reducing evaporation of the lubricating oil 40 through the lower liquid surface of the lubricating oil 40.

In addition, each of the outer circumferential surface of the hanging portion 262 of the upper thrust portion 26 and the inner circumferential surface of the outer cylindrical portion 322 of the sleeve portion 32 is arranged to be angled radially inward with increasing height, so that the upper capillary seal portion 501 is angled radially inward with increasing height. Accordingly, while the motor 10 is running, a centrifugal force which acts toward a lower end of the upper capillary seal portion 501 is applied to the lubricating oil 40 in the upper capillary seal portion 501. This contributes to preventing the lubricating oil 40 from leaking out of the motor 10 through the upper capillary seal portion 501. In addition, the above arrangements make it possible to secure a sufficient radial thickness and a sufficient strength of an upper portion of the outer cylindrical portion 322. This contributes to securing a sufficient radial thickness and a sufficient strength of a portion of the top plate portion 331 of the rotor hub portion 33 in the vicinity of a boundary between the top plate portion 331 and the outer cylindrical portion 322.

### 3. Example Modifications

While preferred embodiments of the present invention have been described above, it is to be understood that the present invention is not limited to the above-described preferred embodiments.

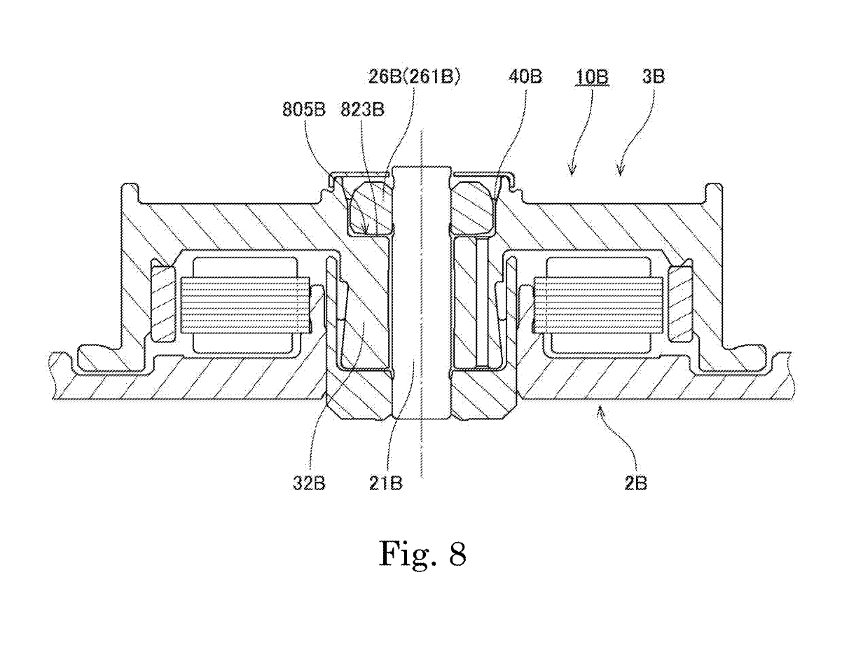

FIG. 8 is a vertical sectional view of a motor 10B according to a modification of the second preferred embodiment. In the modification illustrated in FIG. 8, an upper thrust portion 26B includes only a plate portion 261B arranged to extend radially outward from an upper portion of a shaft 21B. As illustrated in FIG. 8, in the motor 10B, a lower surface of the plate portion 261B in a stationary portion 2B and an upper surface of a sleeve portion 32B in a rotating portion 3B may be arranged axially opposite to each other with a thrust gap 805B, which has a lubricating oil 40B arranged therein, therebetween to define a thrust bearing portion 823B at the thrust gap 805B.

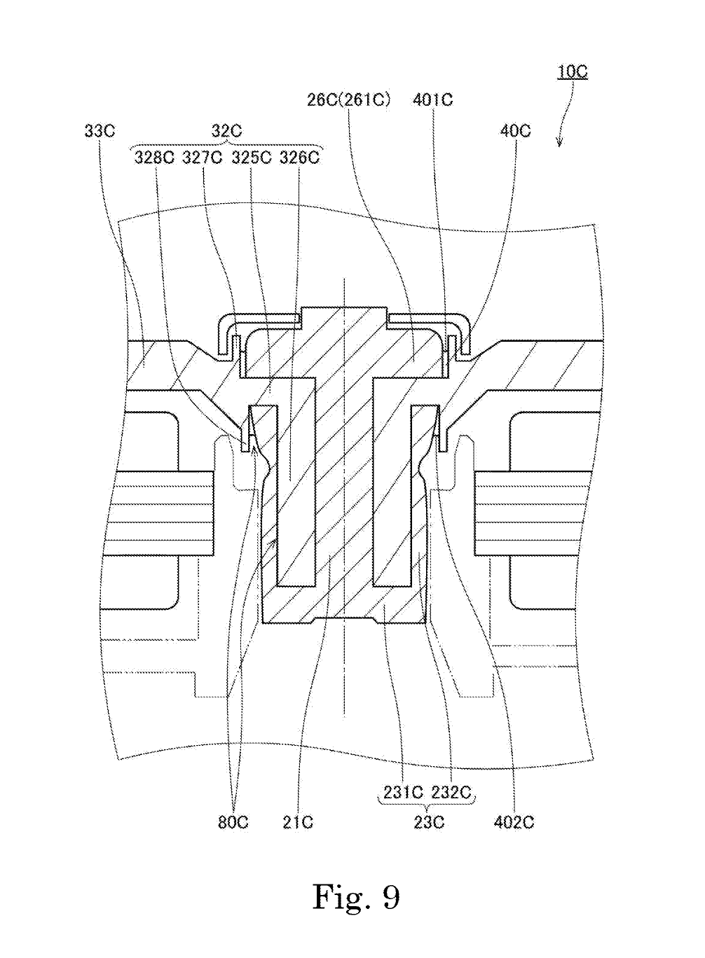

FIG. 9 is a partial vertical sectional view of a motor 10C according to another modification of the second preferred embodiment. In the modification illustrated in FIG. 9, a sleeve portion 32C has a structure different from that of the sleeve portion 32A according to the above-described first preferred embodiment and that of the sleeve portion 32 according to the above-described second preferred embodiment. The sleeve portion 32C includes an annular portion 325C, an inner cylindrical portion 326C, an upper projecting portion 327C, and a lower projecting portion 328C. The annular portion 325C is substantially in the shape of a circular ring. An outer edge of the annular portion 325C of the sleeve portion 32C is integrally defined with a rotor hub portion 33C. The inner cylindrical portion 326C is a substantially cylindrical portion arranged to extend downward from an inner edge of the annular portion 325C. In addition, the upper projecting portion 327C is a substantially cylindrical portion arranged to project upward from the outer edge of the annular portion 325C. Further, the lower projecting portion 328C is a substantially cylindrical portion arranged to project downward from the outer edge of the annular portion 325C. An upper thrust portion 26C includes only a plate portion 261C arranged to extend radially outward from an upper portion of a shaft 21C. A cup portion 23C includes a circular plate portion 231C arranged to extend radially outward from a lower portion of the shaft 21C, and a substantially cylindrical wall portion 232C arranged to extend upward from an outer edge of the circular plate portion 231C.

Referring to FIG. 9, a lubricating oil 40C is arranged in a minute gap 80C between the sleeve portion 32C and a combination of the shaft 21C, the cup portion 23C, and the upper thrust portion 26C. When the motor 10C is stationary, an upper liquid surface 401C of the lubricating oil 40C is positioned in a gap between an outer circumferential surface of the plate portion 261C of the upper thrust portion 26C and an inner circumferential surface of the upper projecting portion 327C of the sleeve portion 32C. In addition, when the motor 10C is stationary, a lower liquid surface 402C of the lubricating oil 40C is positioned in a gap between an outer circumferential surface of the wall portion 232C of the cup portion 23C and the lower projecting portion 328C of the sleeve portion 32C.

Also in each of the modifications illustrated in FIGS. 8 and 9, an upper end of the stationary portion of the motor is arranged at a level higher than that of an upper end of the rotating portion of the motor. Accordingly, when an inner wall of a casing and a fan motor are brought into contact with each other, the inner wall of the casing will make contact with the stationary portion before touching the rotating portion. This contributes to preventing the contact between the inner wall of the casing and the fan motor from affecting driving of the fan motor. In particular, in each of the modifications illustrated in FIGS. 8 and 9, an upper end of the shaft is arranged at a level higher than that of an upper surface of the upper thrust portion. This allows the inner wall of the casing to be brought into contact with the upper end of the shaft instead of the upper thrust portion. This contributes to preventing a change in the shape of the upper thrust portion, which would affect performance of a bearing mechanism.

Note that details of the structure and the shape of a motor according to a preferred embodiment of the present invention may differ from details of the structure and the shape of each motor as illustrated in the accompanying drawings of the present application. Also note that features of the above-described preferred embodiments and the modifications thereof may be combined appropriately as long as no conflict arises.

Preferred embodiments of the present invention are applicable to, for example, fan motors.

1. A fan motor comprising:
a motor including a stationary portion including a stator, and a rotating portion supported through a bearing portion to be rotatable about a central axis extending in a vertical direction with respect to the stationary portion, the rotating portion including a magnet arranged opposite to the stator; and
an impeller arranged to rotate together with the rotating portion of the motor; wherein
the stationary portion includes:
a shaft arranged to extend along the central axis; and
an upper thrust portion arranged to extend radially outward from an upper portion of the shaft;
the rotating portion includes:
a sleeve portion arranged radially opposite to the shaft and axially opposite to the upper thrust portion; and
a rotor hub portion arranged to extend in an annular shape around the sleeve portion, and arranged to have the impeller fixed thereto; and
an upper end of the stationary portion is arranged at a level higher than that of an upper end of the rotating portion.

2. The fan motor according to claim 1, wherein, at the bearing portion, the stationary and rotating portions are arranged opposite to each other with a gap therebetween, the gap having a lubricating oil arranged therein.

3. The fan motor according to claim 1, wherein at least a portion of at least one of the shaft and the upper thrust portion is arranged at a level higher than that of an upper end of the impeller.

4. The fan motor according to claim 3, wherein at least a portion of the upper thrust portion is arranged at a level higher than that of an upper end of the shaft and that of an upper end of the rotor hub portion.

5. The fan motor according to claim 1, wherein
the upper thrust portion includes:
a plate portion fixed to the upper portion of the shaft, and arranged to extend radially outward from the upper portion of the shaft; and
a hanging portion arranged to extend downward from an outer edge portion of the plate portion; and
the hanging portion is arranged radially opposite to the sleeve portion.

6. The fan motor according to claim 2, wherein
the gap includes:
a first thrust gap having the lubricating oil arranged therein; and
a second thrust gap having the lubricating oil arranged therein, and arranged at a level lower than that of the first thrust gap; and
the bearing portion includes:
a first thrust bearing portion at which the stationary and rotating portions are arranged axially opposite to each other with the first thrust gap therebetween; and
a second thrust bearing portion at which the stationary and rotating portions are arranged axially opposite to each other with the second thrust gap therebetween.

7. The fan motor according to claim 6, wherein
the upper thrust portion includes:
a plate portion fixed to the upper portion of the shaft, and arranged to extend radially outward from the upper portion of the shaft; and
a hanging portion arranged to extend downward from an outer edge portion of the plate portion, and arranged radially opposite to the sleeve portion; and
at the first thrust bearing portion, a lower surface of the hanging portion and an upper surface of the sleeve portion are arranged axially opposite to each other with the first thrust gap therebetween.

8. The fan motor according to claim 7, wherein
the impeller includes:
a blade support portion fixed to the rotor hub portion; and
a blade portion arranged to extend radially outward from the blade support portion; and
the first thrust bearing portion is arranged at a level lower than that of an upper end of the blade portion.

9. The fan motor according to claim 1, further comprising a housing including an air inlet and an air outlet, and arranged to house at least a portion of the motor and at least a portion of the impeller therein.

10. The fan motor according to claim 9, wherein
the housing includes:
a side wall portion arranged to house the at least a portion of the motor and the at least a portion of the impeller radially inside thereof; and
an upper plate arranged to extend radially inward from an upper end of the side wall portion to cover at least a portion of an upper surface of the impeller; and
at least a portion of at least one of the shaft and the upper thrust portion is arranged at a level higher than that of an upper end of the upper plate.
